(19) United States
(12) Patent Application Publication
(10) Pub. No.: US 2012/0213035 A1
(43) Pub. Date: Aug. 23, 2012

(54) BOARD FOR SYNTHETIC APERTURE BEAMFORMING APPARTUS

(75) Inventors: Yang Mo YOO, Gyeonggi-do (KR); Tai-Kyong SONG, Seoul (KR); Jin Ho CHANG, Seoul (KR); Jeong CHO, Seoul (KR); Jong Ho PARK, Incheon (KR)

(73) Assignee: Industrial Cooporation Foundation Sogang University, Seoul (KR)

(21) Appl. No.: 13/293,267

(22) Filed: Nov. 10, 2011

(30) Foreign Application Priority Data
Feb. 23, 2011 (KR) 1020110016005

(51) Int. Cl. H04B 1/02

(52) U.S. Cl. 367/138

(57) ABSTRACT

The present invention relates to a board for a synthetic aperture ultrasound imaging apparatus which includes an analog to digital converter converting M analog channel data into M digital channel data; a partial beamformer unit including N partial beamformers generating N partial beams from the M digital channel data; and an adder adding a partial beam stored in a k-th synthetic aperture memory among a plurality of synthetic aperture memories and a partial beam outputted from a k+1-th partial beamformer to input the added partial beam to a k+1-th synthetic aperture memory. The present invention can facilitate an increase in the number of channels by adding a board without transmitting a lot of channel data between boards by exchanging and synthesizing a part of the scanline data between the boards at rear ends of the boards.

### TECHNICAL FIELD

The present invention relates to a board for a synthetic aperture beamforming apparatus, and more particularly, to a board for a synthetic aperture beamforming apparatus that can facilitate an increase in the number of channels by adding a board by exchanging and synthesizing scanline data between boards instead of transmitting a lot of channel data between the boards, reduce channel data transmitted from an analog to digital converter (ADC) to a beamformer by allowing two beamformers to share the channel data, and facilitate an increase in the number of synthetic apertures by increasing the number of beamformers.

### BACKGROUND OF THE INVENTION

In a general synthetic aperture technique, an ultrasonic wave is transmitted once and N elements receive the ultrasonic wave to perform receive-beamforming based on a receiving delay, and after the process is repeated M times, a signal is synthesized based on a transmitting delay for each case to produce one scanline. In this case, N refers to the number of channels and M refers to the number of synthetic transmit apertures.

In a conventional synthetic aperture technique, each element in an array transducer transceives an ultrasonic signal once and then form a desired cross-sectional image from the received signals to obtain the result of one-way dynamic focusing of the ultrasonic wave.

In another synthetic aperture technique, several elements transmit ultrasonic signals simultaneously. In this case, acoustic output power (AOP) increases, but a transmit beam pattern does not spread widely compared with the case where one element transmits a transmit beam pattern, which is not useful for the synthetic aperture technique. Meanwhile, there is a method that can acquire relatively high AOP and an azimuth characteristic of a single array element by applying a proper transmit delay time to transducers. That is, the method uses a virtual source and is divided into a bidirectional pixel based focusing (BiPBF) technique in which the virtual source is in front of transducer and a defocusing technique in which the virtual source is after a transducer.

Meanwhile, a memory structure for implementing the synthetic aperture technique includes a front memory structure and a rear memory structure.

The front memory structure should have all the data which is transmitted and received M times in order to completely generate one scanline by using the synthetic aperture technique. A memory positioned in front of a beamformer stores data which is transmitted and received at a physically different position. Thereafter, M partial beamformers generate partial scanlines existing at the physically same position simultaneously by using the stored data. The result of finally adding the partial scanlines corresponds to the output of a synthetic aperture beamforming system performing two-way dynamic focusing.

Unlike the front memory structure, the rear memory structure stores in a memory beamformed (BF) data which is the output of a beamformer. The beamformer receives N channel data to generate one-scanline data. Of the beamformer of the rear memory structure for implementing the synthetic aperture technique, M partial beamformers each generate different scanline data by using data which is transmitted and received once. The generated scanline data is not a complete scanline but a partial scanline. Therefore, the partial scanlines generated by using M different transmitted and received data adjacent to a location of the complete scanline are inputted to an accumulator composed of memories to perform a synthesis.

FIG. 1 illustrates a board for a synthetic aperture ultrasound imaging apparatus having a rear memory structure in the related art.

Referring to FIG. 1, the board for a synthetic aperture ultrasound imaging apparatus in the related art includes an M channel ADC 110 and a beamformer 115. The beamformer 115 includes partial beamformers 120, an adder 130, scanline storage registers 140, and a demultiplexer 150.

The M channel ADC 110 converts M analog channel data into digital channel data, respectively.

The beamformer 115 generates scanlines by beamforming the M channel data.

The partial beamformer 120 generates a partial scanline by using the M channel data.

The adder 130 adds a partial scanline stored in the scanline storage register 140 and the partial scanline inputted from the partial beamformer 120 to store the added partial scanlines in the scanline storage register 140.

The scanline storage register 140 stores the added result of the partial scanlines inputted from the partial beamformer 120 whenever transmitting and receiving ultrasonic waves.

The demultiplexer 150 selects and outputs one of the partial scanlines stored in the scanline storage register 140.

As described above, when the synthetic aperture ultrasound imaging apparatus includes a plurality of beamformers (including the partial beamformers, the adder, the scanline storage registers, and the demultiplexer), it is preferable that all the channel data is reciprocally transmitted between the beamformers to a field programmable gate array (FPGA) included in each of the beamformers, but it is actually difficult to transmit a lot of channel data between the boards or expand the channels by adding a board.

### SUMMARY OF THE INVENTION

The present invention has been made in an effort to provide a board for a synthetic aperture beamforming apparatus that can facilitate an increase in the number of channels by adding a board without transmitting a lot of channel data between boards by exchanging and synthesizing a part of the scanline data between boards at a rear end of the board, reduce data transmitted from an ADC to a beamformer by allowing two beamformers to share channel data, and facilitate an increase in the number of synthetic apertures by increasing the number of beamformers.

Further, the present invention has been made in an effort to provide a board set for a synthetic aperture beamforming apparatus that can facilitate an increase in the number of channels by adding a board without transmitting a lot of channel data between boards by exchanging and synthesizing a part of the scanline data between boards at a rear end of the board, reduce data transmitted from an ADC to a beamformer by allowing two beamformers to share channel data, and facilitate an increase in the number of synthetic apertures by increasing the number of beamformers, and a synthetic aperture beamforming apparatus including the same.

An exemplary embodiment of the present invention provides a board for a synthetic aperture beamforming apparatus, including: an analog to digital converter converting M analog channel data into M digital channel data; a partial beamformer unit including N partial beamformer generating N partial beams from the M digital channel data; and an adder adding a partial beam stored in a k-th synthetic aperture memory among a plurality of synthetic aperture memories and a partial beam outputted from a k+1-th partial beamformer to input the added partial beam to a k+1-th synthetic aperture memory.

The adder may add a partial beam stored in an N−1-th synthetic aperture memory among the plurality of synthetic aperture memories and a partial beam outputted from an N-th partial beamformer to generate a final synthetic beam.

Another exemplary embodiment of the present invention provides a board for a synthetic aperture beamforming apparatus, including: a first analog to digital converter converting M analog channel data into M digital channel data; a second analog to digital converter converting the M analog channel data and L analog channel data into L digital channel data; a first beamformer receiving the M digital channel data and the L digital channel data, generating N partial beams from the received M+L digital channel data, and generating N synthetic beams by using the generated N partial beams; and a second beamformer receiving the M digital channel data and the L digital channel data, generating N partial beams from the received M+L digital channel data, and generating N synthetic beams by using the generated N partial beams.

The first beamformer may receive the M digital channel data from the first analog to digital converter and the L digital channel data from the second beamformer and the second beamformer may receive the L digital channel data from the second analog to digital converter and the M digital channel data from the first beamformer.

The second beamformer may generate N synthetic beams by using the N synthetic beams generated by the second beamformer and the N synthetic beams received from the first beamformer.

Each of the beamformers may include a partial beamformer unit including N partial beamformers generating N partial beams from the M+L digital channel data; an adder adding a partial beam stored in a k-th synthetic aperture memory among the plurality of synthetic aperture memories included in each of the beamformers and a partial beam outputted from a k+1-th partial beamformer to input the added partial beam to the k+1-th synthetic aperture memory; and a demultiplexer selecting and outputting the partial beams stored in each of the plurality of synthetic aperture memories included in each of the beamformers.

Yet another exemplary embodiment of the present invention provides a board for a synthetic aperture beamforming apparatus, including: a first analog to digital converter converting M analog channel data into M digital channel data; a second analog to digital converter converting the M analog channel data and L analog channel data into L digital channel data; a first beamformer receiving the M+L digital channel data, generating N partial beams from the received M+L digital channel data, and generating N synthetic beams by using the generated N partial beams; a second beamformer receiving the M+L digital channel data from the first beamformer, generating N partial beams from the received M+L digital channel data, and generating N synthetic beams by using the generated N partial beams; a third beamformer receiving the M+L digital channel data, generating N partial beams from the received M+L digital channel data, and generating N synthetic beams by using the generated N partial beams; and a fourth beamformer receiving the M+L digital channel data from the third beamformer, generating N partial beams from the received M+L digital channel data, and generating N synthetic beams by using the generated N partial beams.

The first beamformer may receive the M digital channel data from the first analog to digital converter and the L digital channel data from the fourth beamformer, the second beamformer may receive the M+L digital channel data from the first beamformer, the third beamformer may receive the M digital channel data from the second beamformer and the L digital channel data from the second analog to digital converter, and the fourth beamformer may receive the M+L digital channel data from the third beamformer.

The second beamformer may generate N synthetic beams by using the N synthetic beams generated by the second beamformer and the N synthetic beams received from the first beamformers, the third beamformer may generate N synthetic beams by using the N synthetic beams generated by the third beamformer and the N synthetic beams received from the second beamformers, and the fourth beamformer may generate N synthetic beams by using N synthetic beams generated by the fourth beamformer and N synthetic beams received from the third beamformer.

Each of the beamformers may include a partial beamformer unit including N partial beamformers generating N partial beams from the M+L digital channel data; an adder adding a partial beam stored in a k-th synthetic aperture memory among the plurality of synthetic aperture memories included in each of the beamformers and a partial beam outputted from a k+1-th partial beamformer to input the added partial beam to the k+1-th synthetic aperture memory; and a demultiplexer selecting and outputting the partial beams stored in each of the plurality of synthetic aperture memories included in each of the beamformers.

Still another exemplary embodiment of the present invention provides a board set for a synthetic aperture beamforming apparatus, including: a first board for a synthetic aperture beamforming apparatus, including: a first analog to digital converter converting M analog channel data into M digital channel data; a second analog to digital converter converting the M analog channel data and L analog channel data into L digital channel data; a first beamformer receiving the M digital channel data and the L digital channel data, generating N partial beams from the received M+L digital channel data, and generating N synthetic beams by using the generated N partial beams; and a second beamformer receiving the M digital channel data and the L digital channel data, generating N partial beams from the received M+L digital channel data, and generating N synthetic beams by using the generated N partial beams; and a second board for a synthetic aperture beamforming apparatus having the same configuration as the first board for a synthetic aperture beamforming apparatus, in which the second board for a synthetic aperture beamforming apparatus uses different digital channel data from the M+L digital channel data and receives the synthetic beams of the second beamformer to generate synthetic beams of the second board.

The first beamformer may receive the M digital channel data from the first analog to digital converter and the L digital channel data from the second beamformer and the second beamformer may receive the L digital channel data from the second analog to digital converter and the M digital channel data from the first beamformer.

The second beamformer may generate N synthetic beams by using the N synthetic beams generated by the second beamformer and the N synthetic beams received from the first beamformer.

Still yet another exemplary embodiment of the present invention provides a synthetic aperture beamforming apparatus, including: a transceiving switch switching transceiving of an ultrasonic signal to an object; a first board for a synthetic aperture beamforming apparatus generating synthetic beams by using channel data generated from the received ultrasonic signal; a second board for a synthetic aperture beamforming apparatus generating synthetic beams by using different channel data from the channel data generated from the received ultrasonic signal; and a channel demultiplexer disposed at front ends of the first and second boards for a synthetic aperture beamforming apparatus, and transmitting channel data positioned within a predetermined range from the center of an aperture to the first board for a synthetic aperture beamforming apparatus and transmitting channel data positioned out of the predetermined range to the first board for a synthetic aperture beamforming apparatus by using the characteristic that an ultrasonic delay curve is symmetrical with respect to the center of the aperture when dividing and transmitting the channel data of the aperture to the first and second boards for a synthetic aperture beamforming apparatus.

According to exemplary embodiments of the present invention, it is possible to facilitate an increase in the number of channels by adding a board without transmitting a lot of channel data between boards by exchanging and synthesizing a part of the scanline data between boards at a rear end of the board. Further, it is possible to process 2M channels in a single board while maintaining M channel data transmitted from an ADC to one beamformer and increase the number of synthetic beams by increasing the number of beamformers in the single board. Therefore, since the channel data is not transmitted between the boards, hardware can be simply implemented. Moreover, it is possible to reduce delay calculation and beamformer logic by half by adding in advance channel data to which the same delay curve is applied.

### BRIEF DESCRIPTION OF THE DRAWINGS

FIG. 1 illustrates a board for a synthetic aperture ultrasound imaging apparatus having a rear memory structure in the related art.

FIG. 2 illustrates a first example (CASE 1) in which a rear memory structure according to a first exemplary embodiment of the present invention is implemented in a board for a synthetic aperture ultrasound imaging apparatus.

FIG. 3 illustrates a second example (CASE 2) in which a rear memory structure according to a second exemplary embodiment of the present invention is implemented in a board for a synthetic aperture ultrasound imaging apparatus.

FIG. 4 illustrates a third example (CASE 3) of implementing a board for a synthetic aperture ultrasound imaging apparatus according to a third exemplary embodiment of the present invention, in which beamformers are added in a single board.

FIG. 5 illustrates a fourth example (CASE 4) of implementing a board for a synthetic aperture ultrasound imaging apparatus according to a fourth exemplary embodiment of the present invention, in which the number of synthetic aperture channels are increased by adding a board.

FIG. 6 illustrates a transceiving switch 600 and a channel demultiplexer 601 which are positioned at a front end of a board for a synthetic aperture ultrasound imaging apparatus according to an exemplary embodiment of the present invention.

FIG. 7 illustrates a method in which when dividing and transmitting all the channels of an aperture into boards 500 and 501, the channel demultiplexer 601 separately transmits inner channels and outer channels of the aperture.

### DETAILED DESCRIPTION OF THE EMBODIMENTS

For ease of understanding, first, an outline of the technical solution for achieving objects of the present invention or the core of the spirit of the present invention is presented before describing the present invention in detail.

According to an exemplary embodiment of the present invention, a board for a synthetic aperture beamforming apparatus includes an analog to digital converter converting M analog channel data into M digital channel data; a partial beamformer unit including N partial beamformers generating N partial beams from the M digital channel data; and an adder adding a partial beam stored in a k-th synthetic aperture memory among a plurality of synthetic aperture memories and a partial beam outputted from a k+1-th partial beamformer to input the added partial beam to a k+1-th synthetic aperture memory.

Hereinafter, the present invention will be described in more detail with reference to exemplary embodiments. However, it will be apparent to those skilled in the art that the following exemplary embodiments are examples of the present invention but the present invention is not limited by the exemplary embodiments. The configuration of the present invention for clarifying the technical solution is described in detail with reference to the accompanying drawings based on the exemplary embodiments of the present invention, in which when describing each drawings, elements in other drawings may be referred to, if necessary. Further, in describing the present invention, well-known functions or constructions and all matters will not be described in detail since they may unnecessarily obscure the understanding of the present invention.

In the case of applying a synthetic aperture (SA) beamforming technique to an ultrasound imaging apparatus, as the number of synthetic beams are increased, resolution is improved compared to an image obtained by the conventional beamforming.

Therefore, exemplary embodiments of the present invention are to improve resolution by increasing the number of synthetic beams. First, a structure of an apparatus using synthetic aperture beamforming is described. In a current technological level, the number of ADC channels which can be stably connected to one logic core is 32 and the number of channels which can be stably applied to one board is 64. An example of the logic core may include an FPGA or an application specific integrated circuit (ASIC).

A structure of a board included in an ultrasound imaging apparatus using ultrasonic synthetic aperture beamforming may be configured as described below.

As a basic structure for implementing a synthetic aperture, there are a front memory structure in which transmitted and received channel data for all beams is stored at a front end of a beamformer and then a synthetic beam is generated, and a rear memory structure in which partial beams are generated for every transmission and reception, stored in a memory behind the beamformer, and shifted and accumulated to generate a synthetic beam. The rear memory structure is exemplified in the present invention.

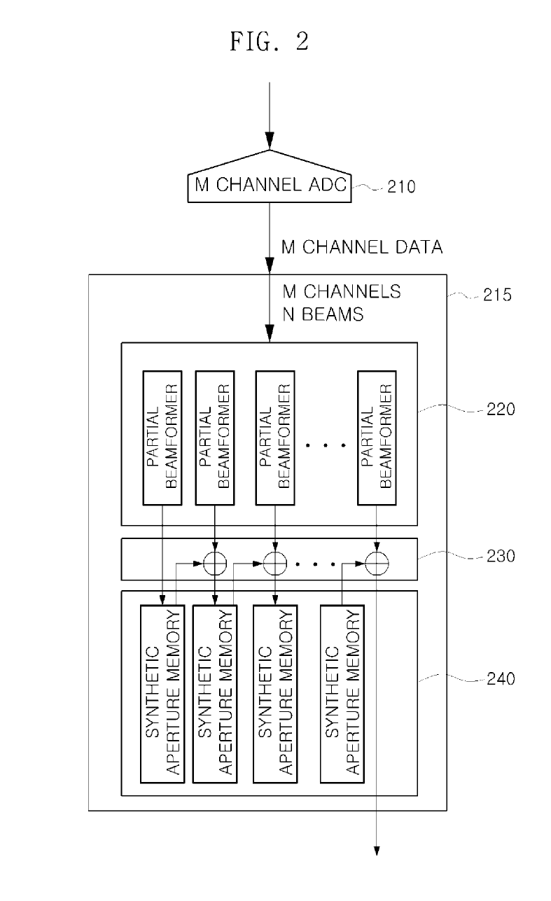

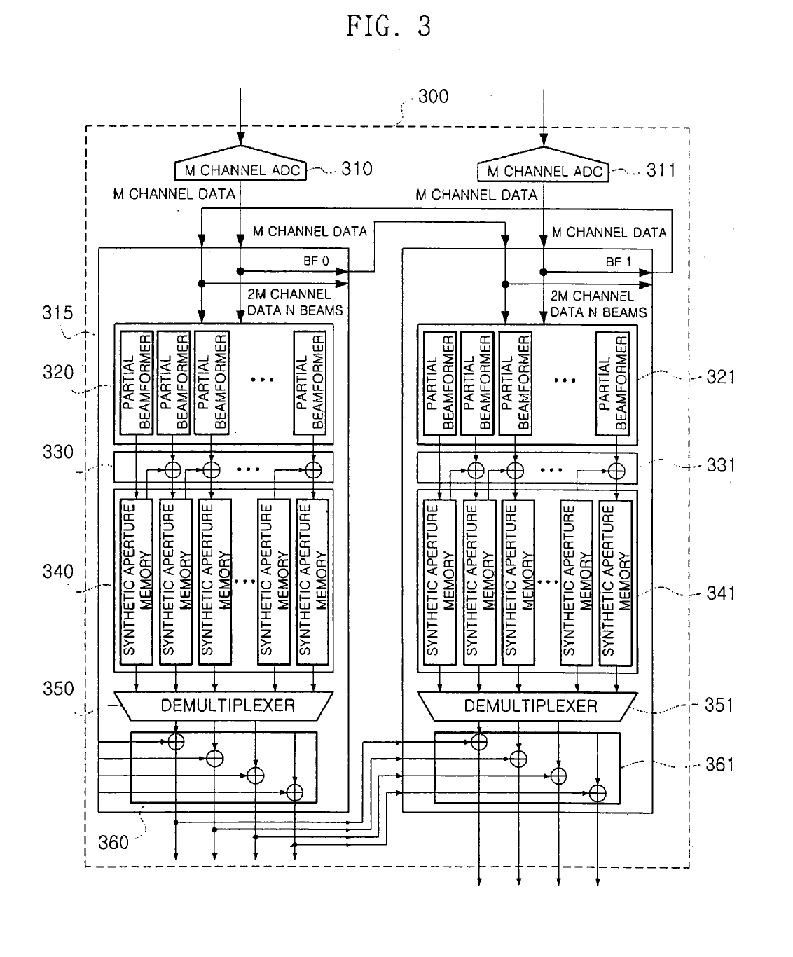

A structure for implementing the rear memory structure according to the exemplary embodiment of the present invention in a single board includes two structures as shown in FIGS. 2 and 3.

FIG. 2 illustrates a first example (CASE 1) in which a rear memory structure according to a first exemplary embodiment of the present invention is implemented in a board for a synthetic aperture ultrasound imaging apparatus.

Referring to FIG. 2, a board for a synthetic aperture ultrasound imaging apparatus includes an M channel ADC 210 and a beamformer 215. The beamformer 215 includes a partial beamformer 220, an adder 230, and a synthetic aperture memory 240.

As shown in FIG. 2, the board for a synthetic aperture ultrasound imaging apparatus generates N partial beams at the same scanline position from M channel data.

The M channel ADC 210 as an ADC having M (M is a natural number) channels converts received channel data into digital data.

The beamformer 215 generates N partial beams from M channel data received from the M channel ADC 210 and beamforms the generated partial beams.

The partial beamformer 220 generates N partial beams corresponding to the same scanline position by using the received digital data. The partial beamformer 220 may include N beamformers generating the partial beams.

The adder 230 adds the N partial beams generated by the partial beamformer 220 in sequence for every transmission and reception of ultrasonic waves to beamform the partial beams. In this case, the partial beams may be beamformed by using the synthetic aperture memory. The partial beams may be beamformed while being added through a summing chain. In this case, the number of the synthetic aperture memories included in the adder 230 is N−1.

When the adder 230 adds the partial beams received from the partial beamformer 220, as a result of finally adding the partial beams, one synthetic beam obtained by adding the partial beam generated by using the M channel data N times is generated.

The synthetic aperture memory 240 is a memory which is used to store the partial beam temporarily beamformed in the process of adding the partial beams in sequence by the adder 230 for every transmission and reception of ultrasonic waves and add a subsequently received partial beam to the stored partial beam.

FIG. 3 illustrates a second example (CASE 2) in which a rear memory structure according to a second exemplary embodiment of the present invention is implemented in a board for a synthetic aperture ultrasound imaging apparatus.

Adders 330 and 331 of FIG. 3 generate and output N synthetic beams at different scanline positions with 2M channel data, respectively and consequently, output 2M channels and 2N synthetic beams.

Referring to FIG. 3, the board for a synthetic aperture ultrasound imaging apparatus includes M channel ADCs 310 and 311 and beamformers 315 and 316. The beamformer 315 includes partial beamformers 320, an adder 330, synthetic aperture memories 340, a demultiplexer 350, and a synthesis unit 360 and the beamformer 316 includes partial beamformers 321, an adder 331, synthetic aperture memories 341, a demultiplexer 351, and a synthesis unit 361.

The M channel ADCs 310 and 311 each of which has M channels convert received channel data into digital data and input the converted digital data to the corresponding beamformers 315 and 316.

When it is assumed that the M channel ADC 110 of FIG. 2 processes data of 1-16 channels, the M channel ADC 310 of FIG. 3 may process data of 1-16 channels and the M channel ADC 311 may process data of 17-32 channels. As a result, in a second example shown in FIG. 3, synthetic beams can be generated using more channel data than in the first example shown in FIG. 2.

The beamformers 315 and 316 exchange the M channel data separately received from the M channel ADCs 310 and 311 and the beamformers 315 and 316 each synthesize N beams at different positions with 2 M channel data to generate 2 M channels and 2N beams. In this case, the synthesis unit 361 of the beamformer 316 may be used to receive synthetic beam data of the synthesis unit 360 of the beamformer 315 and generate synthetic beams.

Each of the partial beamformers 320 and 321 generates N partial beams corresponding to the different scanline positions by using the received digital data.

The adders 330 and 331 add the N partial beams generated by the partial beamformers 320 and 321 in sequence for every transmission and reception of ultrasonic waves to beamform the partial beams. In this case, the partial beam can be synthesized by using a synthetic aperture memory. The partial beams may be synthesized while being added through a summing chain.

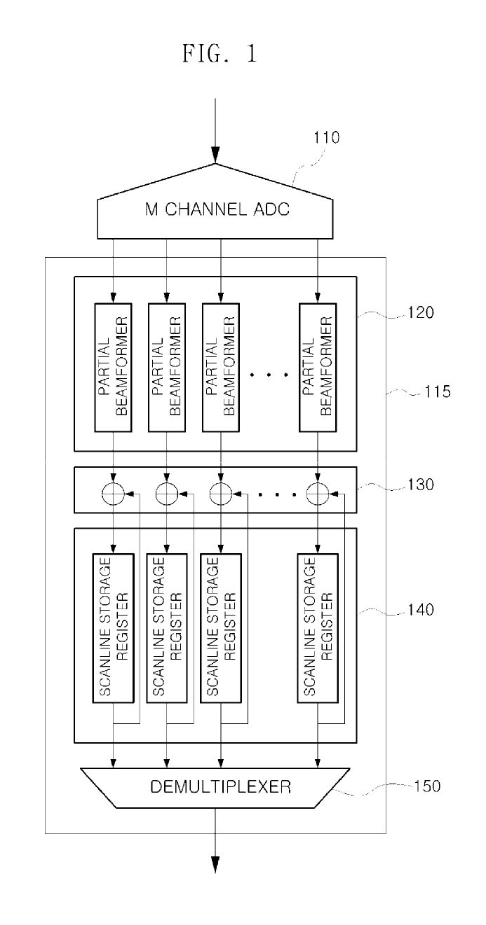

The synthetic aperture memories 340 and 341 have the same configuration as the synthetic aperture memory 240 shown in FIG. 2 and the demultiplexers 350 and 351 have the same configuration as the demultiplexer 150 shown in FIG. 1, and therefore the a detailed description thereof is omitted.

The synthesis unit 360 synthesizes the beams outputted from the demultiplexer 350 to output N synthetic beams at different positions.

The synthesis unit 361 synthesizes the beams outputted from the demultiplexer 351 and the beams transmitted from the synthesis unit 360 to output N synthetic beams at different positions. That is, the 2M channel data and N synthetic beams of the synthesis unit 360 are connected to an input terminal of the synthesis unit 361 and the board for a synthetic aperture ultrasound imaging apparatus finally outputs total 2M channels and 2N synthetic beams.

As a result, the beamformers in the board for a synthetic aperture ultrasound imaging apparatus according to the second exemplary embodiment of the present invention generates and outputs the N synthetic beams at different positions with the 2M channel data individually and consequently, outputs the total 2M channels and 2N synthetic beams.

In the board for a synthetic aperture ultrasound imaging apparatus according to the second exemplary embodiment of the present invention, since the two beamformers 315 and 316 share receiving channels, the number of channel data which one ASIC receives from the ADC is M, which makes it possible to easily design hardware.

It is possible to generate a multibeam by demuxing the output from the synthetic aperture memories 340 and 341 and performing selective synthesis. For example, under the condition where the same frame rate is maintained, when the distance between the scanlines is 1, 0.5, or 0.25, 2M channels and 2N synthetic beams, 2M channels and N synthetic beams, or 2M channels and 0.5N synthetic beams are synthesized, which may be selectively performed. Therefore, it is possible to flexibly control the number of synthetic beams, the distance between the scanlines, and the number of frames.

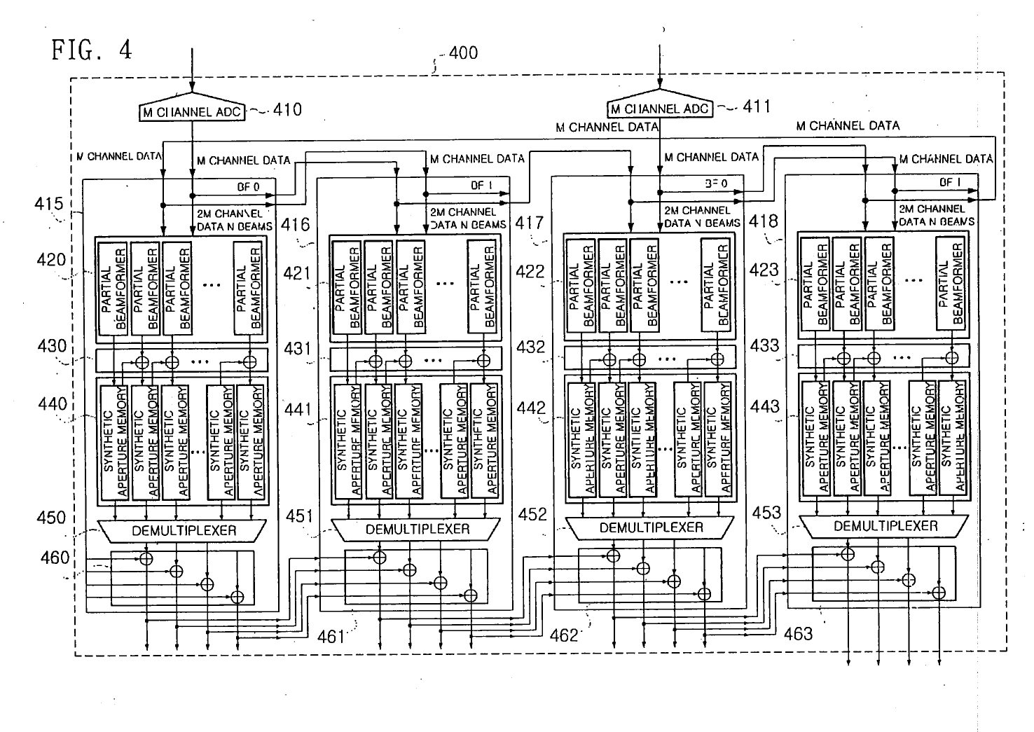

FIG. 4 illustrates a third example (CASE 3) of implementing a board for a synthetic aperture ultrasound imaging apparatus according to a third exemplary embodiment of the present invention, in which beamformers are added in a single board.

Referring to FIG. 4, a board 400 for an ultrasound imaging apparatus according to a third exemplary embodiment of the present invention includes M channel ADCs 410 and 411 and beamformers 415, 416, 417, and 418. The beamformer 415 includes partial beamformers 420, an adder 430, synthetic aperture memories 440, a demultiplexer 450, and a synthesis unit 460 and the beamformer 416 includes partial beamformers 421, an adder 431, synthetic aperture memories 441, a demultiplexer 451, and a synthesis unit 461.

Beamformers 417 and 418 correspond to the beamformers 415 and 416, respectively, and have the same structure, and therefore a detailed description thereof is omitted.

The board for a synthetic aperture ultrasound imaging apparatus according to the third exemplary embodiment of the present invention shown in FIG. 4 may be configured by adding the beamformers 417 and 418 to the board for a synthetic aperture ultrasound imaging apparatus according to the second exemplary embodiment of the present invention shown in FIG. 3. In this case, each of the beamformers 415, 416, 417 and 418 shown in FIG. 4 uses 2M channel data similarly as in FIG. 3, but the number of synthetic aperture beams can be increased by adding the beamformers.

Referring to FIG. 4, the beamformer 415 receives M channel data from the M channel ADC 410 and M channel data of the M channel ADC 411 from the beamformer 418.

The beamformer 415 transmits the M channel data from the M channel ADC 410 and the M channel data from the M channel ADC 411 to the beamformer 416.

The beamformer 416 transmits the M channel data from the M channel ADC 410 among the received 2M channel data to the beamformer 417.

The beamformer 417 directly receives M channel data from the M channel ADC 411 and M channel data of the M channel ADC 410 from the beamformer 416 and transmits the 2M channel data to the beamformer 418.

The beamformer 418 transmits the M channel data from the M channel ADC 411 among the received 2M channel data to the beamformer 415.

Components of the beamformers 415, 416, 417, and 418 are the same as those shown in FIG. 3 and therefore, a detailed description thereof is omitted.

As described above, the number of synthetic beams can be simply increased by increasing the number of beamformers in the single board 400. In particular, in FIG. 4 similarly as FIG. 3, since the received channel data is not increased, it is not difficult to increase only the number of beamformers in the single board.

The board for a synthetic aperture ultrasound imaging apparatus according to the third exemplary embodiment of the present invention may generate 2M channels and 4N synthetic beams, 2M channels and 2N synthetic beams, or 2M channels and N synthetic beams, respectively, when the distance between the scanlines is 1, 0.5, or 0.25. Therefore, it is possible to flexibly control the number of synthetic beams, the distance between the scanlines, and the number of frames.

When the beamformers are provided in plural as shown in FIG. 4, it is preferable that all the channel data is reciprocally transmitted between the beamformers to an FPGA included in each of the beamformers.

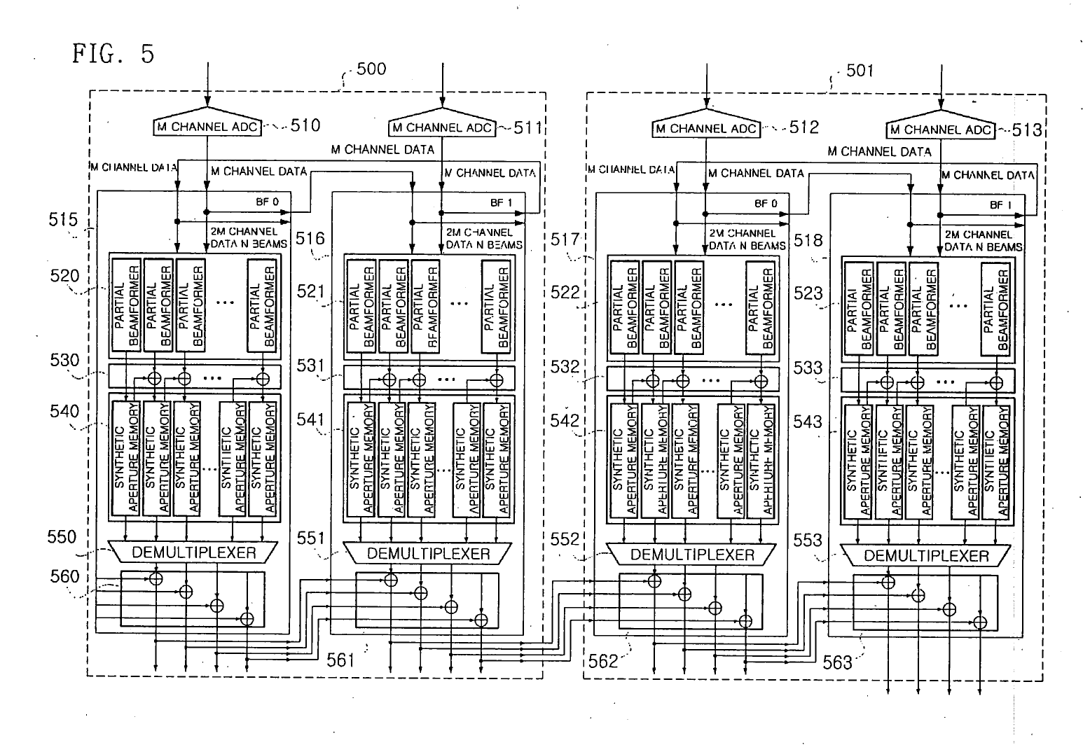

FIG. 5 illustrates a fourth example(CASE 4) implementing a board for a synthetic aperture ultrasound imaging apparatus according to a fourth exemplary embodiment of the present invention, in which the number of synthetic aperture channels are increased by adding a board.

Referring to FIG. 5, a board for a synthetic aperture ultrasound imaging apparatus according to the fourth exemplary embodiment of the present invention includes a board 0 500 and a board 1 501. The board 0 500 includes M channel ADCs 510 and 511 and beamformers 515 and 516 and the board 1 501 includes M channel ADCs 512 and 513 and beamformers 517 and 518.

The M channel ADCs 510 and 511, the beamformers 515 and 516, the M channel ADCs 512 and 513, and the beamformers 517 and 518 correspond to the components shown in FIG. 4, and therefore, the same description is omitted and differences will be described.

Each of the board 0 500 and the board 1 501 is the same as the board for a synthetic aperture ultrasound imaging apparatus having the rear memory structure according to the second exemplary embodiment of the present invention shown in FIG. 3.

Referring to FIG. 5, scanline data of a synthesis unit 561 included in the board 0 500 is inputted to a synthetic unit 562 included in the board 1 501 and the synthesis unit 562 uses the scanline data inputted from the synthesis unit 561 to synthesize scanline data.

Meanwhile, in FIG. 5 unlike FIG. 4, 2M channel data processed by a beamformer 516 is not transmitted to a beamformer 517 of the other board. The beamformers 517 and 518 perform beamforming by using other channel data outputted by M channel ADCs 512 and 513 included in the board 1 501.

Therefore, as shown in FIG. 5, 4M channel data may be used by adding a board instead of using the 2M channel data as shown in FIGS. 3 and 4. For example, data of 1 to 32 channels is used in FIGS. 3 and 4, but data of 1 to 64 channels may be used in FIG. 5. That is, it is possible to increase the number of channels of the synthetic aperture by adding the board and perform the synthetic aperture without transmitting the channel data between the boards.

Therefore, the board for a synthetic aperture ultrasound imaging apparatus according to the fourth exemplary embodiment of the present invention may generate 4M channels and 2N synthetic beams, 4M channels and N synthetic beams, and 4M channels and 0.5N synthetic beams, respectively when the distance between the scanlines is 1, 0.5, and 0.25. Therefore, it is possible to flexibly control the number of synthetic beams, the distance between the scanlines, and the number of frames.

Since RF channel data as data of each of the channels outputted from the ADCs is large, it is difficult to transmit the RF channel data between the boards. Meanwhile, since scanline data as data which is added by applying a delay time is small compared with the RF channel data, it is possible to transmit the scanline data between the boards. Therefore, based on the fact in the fourth exemplary embodiment of the present invention, the board for a synthetic aperture ultrasound imaging apparatus is effectively expanded.

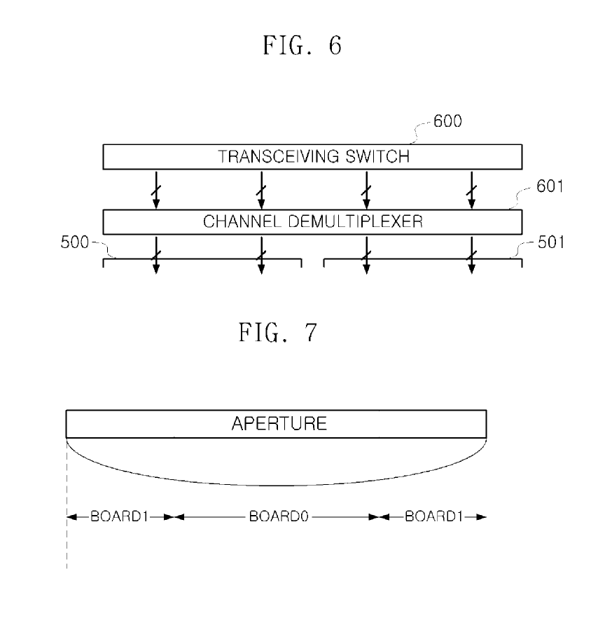

FIG. 6 illustrates a transceiving switch 600 and a channel demultiplexer 601 which are positioned at a front end of a board for a synthetic aperture ultrasound imaging apparatus according to an exemplary embodiment of the present invention.

FIG. 7 illustrates a method in which when dividing and transmitting all the channels of an aperture into boards 500 and 501, the channel demultiplexer 601 separately transmits inner channels and outer channels of the aperture.

A convex or linear array probe has the characteristic that a delay curve of a generated partial beam is symmetrical with respect to the center of an aperture. By using this, it is possible to reduce delay calculation and beamformer logic by half by adding in advance channel data to which the same delay curve is to be applied. Meanwhile, because the number of probe elements is different from the number of the aperture channels, a high voltage multiplexer (HV MUX) is used and as a result, a beamformer receives RF data from different channels for every transmission and reception. A channel demultiplexer 601 is disposed at front ends of the boards 500 and 501 after the transceiving switch 600 in order to implement this in the synthetic aperture structure.

Since the channel demultiplexer 601 disentangles crossing channels and transmits the channels to the boards 500 and 501, each of the beamformers of the board can receive RF data of the same channel after every transmission and reception. In the case of dividing and transmitting all the channels of the aperture to the boards, only when the channels are separately transmitted to the inside/outside of the aperture, it is possible to reduce the used logic and memories.

Referring to FIG. 7, the channel demultiplexer 601 assigns the central part of the aperture to a board 0 500 and side parts of the aperture to boards 1 501.

As described above, while this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A board for a synthetic aperture beamforming apparatus, comprising:
an analog to digital converter converting M (M is an arbitrary natural number) analog channel data into M digital channel data; a partial beamformer unit including N (N is an arbitrary natural number) partial beamformers generating N partial beams from the M digital channel data; and
an adder adding a partial beam stored in a k-th (k is an arbitrary natural number) synthetic aperture memory among a plurality of synthetic aperture memories and a partial beam outputted from a k+1-th partial beamformer to input the added partial beam to a k+1-th synthetic aperture memory.

2. The board for a synthetic aperture beamforming apparatus according to claim 1, wherein the adder adds a partial beam stored in an N−1-th synthetic aperture memory among the plurality of synthetic aperture memories and a partial beam outputted from an N-th partial beamformer to generate a final synthetic beam.

3. A board for a synthetic aperture beamforming apparatus, comprising:
a first analog to digital converter converting M (M is an arbitrary natural number) analog channel data into M digital channel data;
a second analog to digital converter converting the M analog channel data and L (L is an arbitrary natural number) analog channel data into L digital channel data;
a first beamformer receiving the M digital channel data and the L digital channel data, generating N partial beams from the received M+L digital channel data, and generating N synthetic beams by using the generated N partial beams; and
a second beamformer receiving the M digital channel data and the L digital channel data, generating N partial beams from the received M+L digital channel data, and generating N synthetic beams by using the generated N partial beams.

4. The board for a synthetic aperture beamforming apparatus according to claim 3, wherein the first beamformer receives the M digital channel data from the first analog to digital converter and the L digital channel data from the second beamformer and the second beamformer receives the L digital channel data from the second analog to digital converter and the M digital channel data from the first beamformer.

5. The board for a synthetic aperture beamforming apparatus according to claim 3, wherein the second beamformer generates N synthetic beams by using N synthetic beams generated by the second beamformer and N synthetic beams received from the first beamformer.

6. The board for a synthetic aperture beamforming apparatus according to claim 3, wherein each of the beamformers includes a partial beamformer unit including N partial beamformers generating N partial beams from the M+L digital channel data; an adder adding a partial beam stored in a k-th (k is an arbitrary natural number) synthetic aperture memory among the plurality of synthetic aperture memories included in each of the beamformers and a partial beam outputted from a k+1-th partial beamformer to input the added partial beam to the k+1-th synthetic aperture memory; and a demultiplexer selecting and outputting the partial beams stored in each of the plurality of synthetic aperture memories included in each of the beamformers.

7. A board for a synthetic aperture beamforming apparatus, comprising:
a first analog to digital converter converting M (M is an arbitrary natural number) analog channel data into M digital channel data;
a second analog to digital converter converting the M analog channel data and L (L is an arbitrary natural number) analog channel data into L digital channel data;
a first beamformer receiving the M+L digital channel data, generating N (N is an arbitrary natural number) partial beams from the received M+L digital channel data, and generating N synthetic beams by using the generated N partial beams;
a second beamformer receiving the M+L digital channel data from the first beamformer, generating N partial beams from the received M+L digital channel data, and generating N synthetic beams by using the generated N partial beams;
a third beamformer receiving the M+L digital channel data, generating N partial beams from the received M+L digital channel data, and generating N synthetic beams by using the generated N partial beams; and
a fourth beamformer receiving the M+L digital channel data from the third beamformer, generating N partial beams from the received M+L digital channel data, and generating N synthetic beams by using the generated N partial beams.

8. The board for a synthetic aperture beamforming apparatus according to claim 7, wherein the first beamformer receives the M digital channel data from the first analog to digital converter and the L digital channel data from the fourth beamformer, the second beamformer receives the M+L digital channel data from the first beamformer, the third beamformer receives the M digital channel data from the second beamformer and the L digital channel data from the second analog to digital converter, and the fourth beamformer receives the M+L digital channel data from the third beamformer.

9. The board for a synthetic aperture beamforming apparatus according to claim 7, wherein the second beamformer generates N synthetic beams by using the N synthetic beams generated by the second beamformer and the N synthetic beams received from the first beamformer, the third beamformer generates N synthetic beams by using the N synthetic beams generated by the third beamformer and the N synthetic beams received from the second beamformer, and the fourth beamformer generates N synthetic beams by using N synthetic beams generated by the fourth beamformer and N synthetic beams received from the third beamformer.

10. The board for a synthetic aperture beamforming apparatus according to claim 7, wherein each of the beamformers includes a partial beamformer unit including N partial beamformers generating N partial beams from the M+L digital channel data; an adder adding a partial beam stored in a k-th (k is an arbitrary natural number) synthetic aperture memory among the plurality of synthetic aperture memories included in each of the beamformers and a partial beam outputted from a k+1-th partial beamformer to input the added partial beam to a k+1-th synthetic aperture memory; and a demultiplexer selecting and outputting the partial beams stored in each of the plurality of synthetic aperture memories included in each of the beamformers.

11. A board set for a synthetic aperture beamforming apparatus, comprising:
a first board for a synthetic aperture beamforming apparatus, including: a first analog to digital converter converting M (M is an arbitrary natural number) analog channel data into M digital channel data;
a second analog to digital converter converting the M analog channel data and L (L is an arbitrary natural number) analog channel data into L digital channel data;
a first beamformer receiving the M digital channel data and the L digital channel data, generating N (N is an arbitrary natural number) partial beams from the received M+L digital channel data, and generating N synthetic beams by using the generated N partial beams; and
a second beamformer receiving the M digital channel data and the L digital channel data, generating N partial beams from the received M+L digital channel data, and generating N synthetic beams by using the generated N partial beams; and
a second board for a synthetic aperture beamforming apparatus having the same configuration as the first board for a synthetic aperture beamforming apparatus, wherein the second board for a synthetic aperture beamforming apparatus uses different digital channel data from the M+L digital channel data and receives the synthetic beams of the second beamformer to generate synthetic beams of the second board.

12. The board set for a synthetic aperture beamforming apparatus according to claim 11, wherein the first beamformer receives the M digital channel data from the first analog to digital converter and the L digital channel data from the second beamformer and the second beamformer receives the L digital channel data from the second analog to digital converter and the M digital channel data from the first beamformer.

13. The board set for a synthetic aperture beamforming apparatus according to claim 11, wherein the second beamformer generates N synthetic beams by using N synthetic beams generated by the second beamformer and the N synthetic beams received from the first beamformer.

14. The board set for a synthetic aperture beamforming apparatus according to claim 11, wherein each of the beamformers includes a partial beamformer unit including N partial beamformers generating N partial beams from the M+L digital channel data; an adder adding a partial beam stored in a k-th (k is an arbitrary natural number) synthetic aperture memory among the plurality of synthetic aperture memories included in each of the beamformers and a partial beam outputted from a k+1-th partial beamformer to input the added partial beam to a k+1-th synthetic aperture memory; and a demultiplexer selecting and outputting the partial beams stored in each of the plurality of synthetic aperture memories included in each of the beamformers.

15. A synthetic aperture beamforming apparatus, comprising:
a transceiving switch switching transceiving of an ultrasonic signal to an object a first board for a synthetic aperture beamforming apparatus generating synthetic beams by using channel data generated from the received ultrasonic signal;
a second board for a synthetic aperture beamforming apparatus generating synthetic beams by using different channel data from the channel data generated from the received ultrasonic signal; and
a channel demultiplexer disposed at front ends of the first and second boards for a synthetic aperture beamforming apparatus, and transmitting channel data positioned within a predetermined range from the center of an aperture to the first board for a synthetic aperture beamforming apparatus and transmitting channel data positioned out of the predetermined range to the second board for a synthetic aperture beamforming apparatus by using the characteristic that a ultrasonic delay curve is symmetrical with respect to the center of the aperture when dividing and transmitting the channel data of the aperture to the first and second boards for a synthetic aperture beamforming apparatus.
